(19) United States
(12) Patent Application Publication
(10) Pub. No.: US 2013/0048622 A1
(43) Pub. Date: Feb. 28, 2013

(54) METHOD AND DEVICE FOR HEATING WINDOWS OF A MOTOR VEHICLE

(71) Applicants: Markus Markowitz, Koln (DE); Dietmar Fischer, Koln (DE); Rob Alders, Neerpelt (BE)

(72) Inventors: Markus Markowitz, Koln (DE); Dietmar Fischer, Koln (DE); Rob Alders, Neerpelt (BE)

(73) Assignee: FORD GLOBAL TECHNOLOGIES, LLC, DEARBORN, MI (US)

(21) Appl. No.: 13/591,550

(22) Filed: Aug. 22, 2012

(30) Foreign Application Priority Data
Aug. 26, 2011 (DE) 102011081636.4

(51) Int. Cl. B60L 1/02

(52) U.S. Cl. 219/203

(57) ABSTRACT

Method and apparatus for heating windows of a motor vehicle with a vehicle heating system which directs warm air onto the windows in a controlled manner, wherein the motor vehicle has electrically heated windows (in particular a front windscreen and/or a rear backlite window) and side windows without electrical heating. The warm air from the vehicle heating system is concentrated on the windows without electrical heating when the electric window heating is switched on.

### CROSS REFERENCE TO RELATED APPLICATIONS

This application claims priority from application 102011081636.4, filed in the German Patent and Trademark Office on Aug. 26, 2011, and hereby incorporated by reference.

### STATEMENT REGARDING FEDERALLY SPONSORED RESEARCH

Not Applicable.

### BACKGROUND OF THE INVENTION

The invention concerns a method for heating windows of a motor vehicle with a vehicle heating and ventilation system that directs warm air onto the windows in a controlled manner, wherein the motor vehicle has electrically heated windows (in particular a front windscreen and/or a rear backlite window) and side windows without electrical heating.

Patent EP1752322B1 discloses a method for heating windows of a motor vehicle. To determine and control the heating power, the relative humidity in the interior of the vehicle is measured using a moisture sensor of a humidity control system. The moisture sensor is installed in the vicinity of the extraction air orifices at the rear interior of the motor vehicle. This improves the heating performance and humidity balance in motor vehicles.

The heat necessary for clearing frost or mist from vehicle windows has been provided either by electrical resistance heaters disposed on or within a window or by warm air directed against a window from a vehicle heating and ventilation system. When present, electrical resistance heaters have been operated independently from, and as a supplement to, the forced air ventilation system. Moreover, a defrost setting of the ventilation system results in directing warm air to both the windscreen and side windows in a fixed, nonadjustable proportion.

Due to improved efficiency and other optimization requirements for modern motor vehicles, a limited or reduced quantity of heat (e.g., waste heat produced by a combustion engine) may be available for window defrosting and demisting. Heating the side windows constitutes a particular problem since they are given a lower priority that the front window or windscreen because the windscreen must preferably be kept clear for legal and technical reasons. Therefore, conventional systems provide a greater volume of the warm air to the windscreen than to the side windows. Furthermore, side windows do not have a fixed position and are not as easily fitted with an electrical resistance heater.

### SUMMARY OF THE INVENTION

In the present invention, heated air from the vehicle heating system is concentrated on windows that do not possess resistance heating when the electric resistance system is switched on for windows that do. Therefore, it is possible to defrost or demist the side windows more quickly. It has been found that when the electric heating is switched on for the corresponding window, usually the windscreen, its supply of hot air can be reduced or even shut off completely. Thus, the limited quantity of hot air available can be deflected to the regions in which it is actually required, namely the windows not heated electrically.

The vehicle heating/ventilation system can be part of an air conditioning system. The term “electrically heated window” means in the present case a window which can be heated by means of an electric resistance heater. This can be cast into or applied over the windows, and typically is comprised of transparent heater elements or thin elements that create minimal visual obstruction.

As a hot air supply and flap system, the usual supply lines and air vents with known types of control flaps can be used. However, additional or modified flaps can also be provided which can shut off completely the hot air supply to electrically heated windows, in particular to the windscreen, while the air supply to the windows not heated electrically is maintained or increased.

Preferably, the concentration of warm air is comprised of directing at least a majority of the warm air to the respective side window(s). Even more preferably, the concentration is comprised of directing the entirety of the warm air from the vehicle heating system to the respective window(s) not having resistance heating since it has been found that an additional supply of warm air is not necessary for an electrically heated window. In a most preferred embodiment, the front window is electrically heated and the entire warm air supply from the vehicle heating is guided onto the side windows.

In one aspect of the invention, a vehicle heating system in a motor vehicle has guides to direct warm air onto the windows and a flap system and controller to control the warm air supply to the windows. The controller is designed to monitor the activity (operation) of an electric window heating system, and the flap system comprises flaps to deflect the warm air onto the unheated windows on the basis of the activity of the electric window heating system.

### BRIEF DESCRIPTION OF THE DRAWINGS

FIG. 1 is a flow diagram of a method for heating the windows of a motor vehicle.

FIG. 2 is a schematic perspective sketch of a region of a car windscreen.

FIG. 3 is a schematic view of the vehicle heating system in FIG. 2.

FIG. 4 is a schematic perspective sketch of the region of a car windscreen with an electric window heating system.

FIG. 5 is a schematic view of the vehicle heating system in FIG. 4.

### DETAILED DESCRIPTION OF PREFERRED EMBODIMENTS

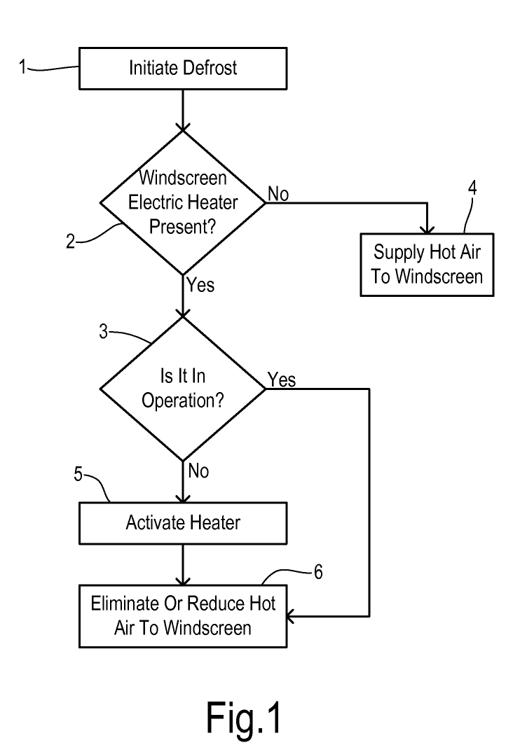

FIG. 1 shows a schematic flow diagram of a method for heating the windows of a motor vehicle. When it becomes necessary to defrost or demist the windows of a motor vehicle, a defrost/demist clearing action is initiated in step 1. This action can be initiated either as a result of the manual pressing of a control button by the operator or as a result of automatic detection (e.g., using an ice or condensation sensor or as a result of a detecting a low temperature during a remote start operation). In step 2, a check is performed to determin whether an electric windscreen heater is present in the vehicle. If not, the hot air from the vehicle heating system is supplied to the windscreen according to conventional volume proportions with any other windows in step 4.

In the event that an electric windscreen heater is present in the vehicle, it is then checked whether this resistance heater is already in operation in step 3. If not already active, the electric windscreen heater is activated in step 5. Then in step 6, the hot air from the vehicle heating system is not supplied to the windscreen or only in a reduced quantity.

The method in FIG. 1 can be implemented in a control system that can be generically installed in vehicles of different types that may or may not possess windows with electrical resistance heaters. In the case of a customized control system for any particular model of motor vehicle, it may be known in advance that an electrically heated window will be present in the vehicle. In such a case, steps 2 and 4 would be skipped.

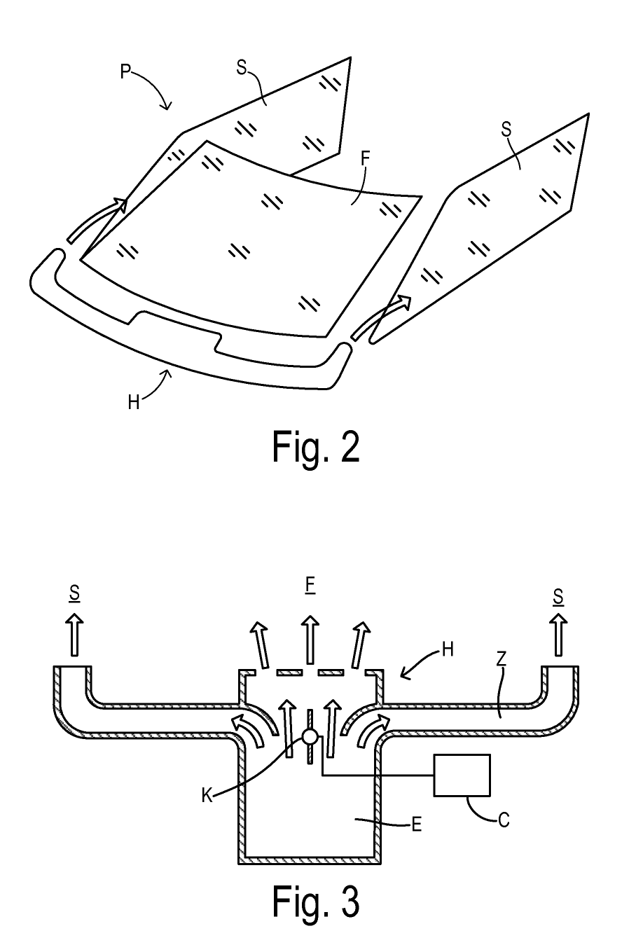

FIGS. 2 and 3 show the case which corresponds to the above step 4, namely no electric windscreen heater is present in the vehicle. This is therefore a view of the prior art to illustrate the differences from the invention. In FIG. 2, the front region of a motor vehicle P is shown around a front window F with side windows S. If it is necessary to defrost or demist the windows F and S of the motor vehicle P, a vehicle heating system H is used with its air guides Z, flaps K, and heater unit E to supply the majority of warm air to the front window F and not to the side windows S. A controller C sets the position of flaps K such that the proportion of warm air flow toward window F is maximized.

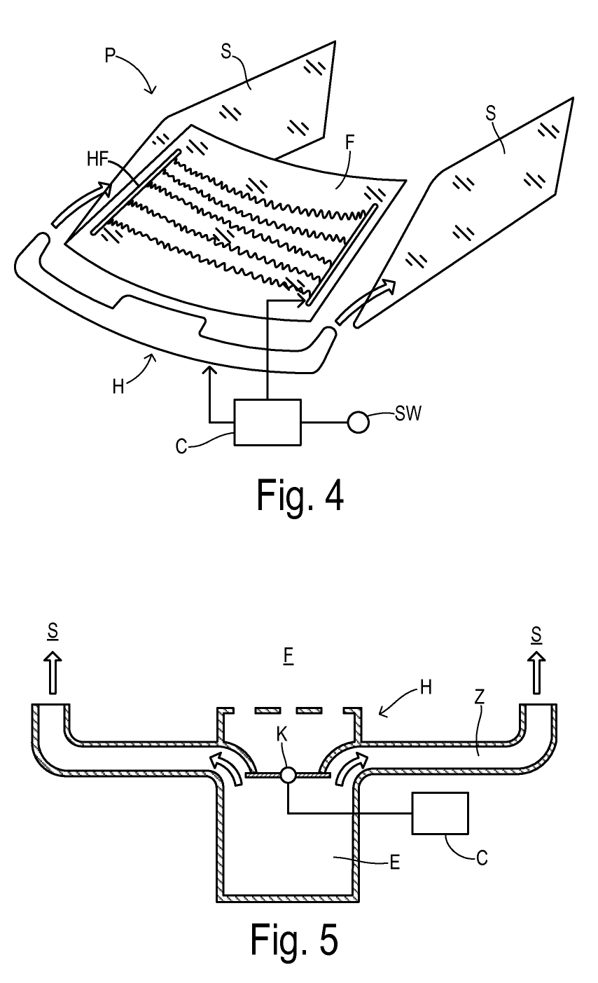

In contrast to this, a preferred embodiment of the invention shown in FIGS. 4 and 5 comprises a corresponding electrical controller C which, on the necessity for defrosting or demisting, activates the electric windscreen heating HF and deflects the majority of or the entire warm air supply from the vehicle heating system H to the side windows S by closing the flap K.

A clearing action (i.e., removal of frost or mist by heating) is initiated via a trigger switch SW coupled to controller C. Trigger switch SW may be a manually actuated push button or may an electronically controlled trigger that operates on an automatic basis. Controller C coordinates the operation of resistance heater HF with the operation of heating and ventilation system H as described above, thereby achieving faster clearing of all windows in the vehicle with less energy requirements since the primary (or sole) clearance action for the windscreen is provided by the activation of the resistance heater and the unneeded warm air that would otherwise have been blown onto the windscreen is instead redirected to the side windows.

What is claimed is:

1. A method for defrosting/demisting first and second windows of a motor vehicle having a ventilation system for directing warm air onto the windows, wherein the first window has a resistance heater disposed therewith, comprising:
receiving an indication for activating a clearing action;
activating the resistance heater as a primary clearance for the first window; and
configuring the ventilation system to concentrate the warm air directed from the ventilation system onto the second window.

2. The method of claim 1 wherein the step of configuring the ventilation system to concentrate the warm air onto the second window is comprised of directing a majority of the warm air onto the second window.

3. The method of claim 1 wherein the step of configuring the ventilation system to concentrate the warm air onto the second window is comprised of directing substantially none of the warm air onto the first window.

4. The method of claim 1 wherein the step of configuring the ventilation system to concentrate the warm air onto the second window is comprised of setting a position of at least one flap in the ventilation system.

5. The method of claim 1 wherein the first window is comprised of one or more of a front windscreen and a rear backlite.

6. The method of claim 1 wherein the second window is comprised of one or more side windows.

7. The method of claim 1 wherein the received indication for activating a clearing action is manually generated.

8. Motor vehicle apparatus comprising:
first and second windows wherein the first window has a resistance heater disposed therewith and the second window lacks any resistance heater;
a ventilation system for directing warm air onto the windows;
a trigger for generating an indication for activating a window clearing action; and
a controller responsive to the indication to activate the resistance heater as a primary clearance for the first window and configuring the ventilation system to concentrate the warm air directed from the ventilation system onto the second window.

9. The apparatus of claim 8 wherein the ventilation system includes a flap and duct system that is configurable to direct selected proportions of the warm air between ducts leading to the first window and the second window.

10. The apparatus of claim 8 wherein the controller configures the ventilation system to direct a majority of the warm air onto the second window.

11. The apparatus of claim 8 wherein the controller configures the ventilation system to directing substantially none of the warm air onto the first window.

12. The apparatus of claim 8 wherein the first window is comprised of one or more of a front windscreen and a rear backlite.

13. The apparatus of claim 8 wherein the second window is comprised of one or more side windows.

14. The apparatus of claim 8 wherein the trigger is comprised of a manually activated switch.
